(19) United States
(12) Patent Application Publication
(10) Pub. No.: US 2026/0272156 A1
(43) Pub. Date: Sep. 17, 2026

(54) BRUSH HEAD FOR ELECTRIC CLEANING BRUSH AND ELECTRIC CLEANING BRUSH

(71) Applicant: Yangzhou Star Oralcare Product Co., Ltd., Yangzhou (CN)

(72) Inventor: Songtao WU, Yangzhou (CN)

(73) Assignee: Yangzhou Star Oralcare Product Co., Ltd., Yangzhou (CN)

(21) Appl. No.: 19/207,446

(22) Filed: May 14, 2025

(30) Foreign Application Priority Data
Mar. 17, 2025 (CN) 2025103131898

(51) Int. Cl. A46B 13/02; A46B 5/00; A46B 13/00

(52) U.S. Cl. CPC A46B 13/02; A46B 5/0095; A46B 13/008; A46B 2200/3033

(57) ABSTRACT

A brush head for an electric cleaning brush and an electric cleaning brush are provided. The brush head for an electric cleaning brush specifically includes: a housing internally provided with an accommodation chamber; a brush disc assembly provided at an end of the housing; a transmission shaft assembly provided in the accommodation chamber and spaced apart from the brush disc assembly; and an oscillating member provided at an end of the transmission shaft assembly and movably connected to the brush disc assembly, where a side of the brush disc assembly facing the oscillating member is provided with a groove; and the oscillating member includes a rotating member provided at the end of the transmission shaft assembly and a fit protrusion including one end provided at an eccentric position of the rotating member and the other end with an outer wall fitting against an inner wall of the groove.

### CROSS-REFERENCE TO THE RELATED APPLICATIONS

This application is based upon and claims priority to Chinese Patent Application No. 202510313189.8, filed on Mar. 17, 2025, the entire contents of which are incorporated herein by reference.

### TECHNICAL FIELD

The present disclosure relates to the technical field of cleaning tools, and in particular to a brush head for an electric cleaning brush and an electric cleaning brush.

### BACKGROUND

Cleaning brushes offer effective cleaning performance and are frequently used in daily life for cleaning kitchens, bathrooms, toilets, and cars, etc.

Existing cleaning brushes typically require manual operation to clean objects, which is inconvenient, time-consuming, and labor-intensive. To address user needs, some manufacturers have improved their cleaning brushes by adopting electric drives to enhance cleaning efficiency. In electric cleaning brushes, the power transmission component employs a transmission shaft and a shift fork that engage with each other to drive the brush head to rotate. However, the engagement point causes significant impact noise during operation.

### SUMMARY

An objective of the present disclosure is to provide a brush head for an electric cleaning brush and an electric cleaning brush, which solves the technical problem of excessive noise during operation of the brush head of the cleaning brush in the prior art.

An embodiment of the present disclosure provides a brush head for an electric cleaning brush, including:
a housing, where the housing is internally provided with an accommodation chamber;
a brush disc assembly, provided at an end of the housing;
a transmission shaft assembly, where the transmission shaft assembly is provided in the accommodation chamber, and spaced apart from the brush disc assembly; and
an oscillating member, where the oscillating member is provided at an end of the transmission shaft assembly and movably connected to the brush disc assembly;
where, a side of the brush disc assembly facing the oscillating member is provided with a groove;
the oscillating member includes:
a rotating member, provided at the end of the transmission shaft assembly; and
a fit protrusion, including one end provided at an eccentric position of the rotating member and the other end with an outer wall fitting against an inner wall of the groove.

The present disclosure designs the oscillating member such that the rotating member drives the fit protrusion to rotate and the brush disc assembly is driven to oscillate, thereby performing cleaning actions with low noise.

The embodiment of the present disclosure may further make the following improvements based on the above technical solution.

Furthermore, the fit protrusion is truncated cone-shaped; and a diameter of a side of the fit protrusion away from the rotating member is denoted as r, while a diameter of a side of the fit protrusion close to the rotating member is denoted as R, R>r. The beneficial effect of this design lies in that the fit protrusion well fits with the groove and drives the brush disc assembly to oscillate.

Furthermore, a taper of the fit protrusion is denoted as α, α≥45°. The beneficial effect of this design lies in that the rotational stability of the fit protrusion is ensured for better oscillation.

Furthermore, the inner wall of the groove includes an inclined section and a vertical section; the inclined section is located at an end of the vertical section away from a bottom of the groove; and the inclined section extends obliquely outward from a junction between the inclined section and the vertical section; and
when the oscillating member is driven by the transmission shaft assembly to eccentrically rotate, the outer wall of the fit protrusion contacts the vertical section. The beneficial effect of this design lies in that the groove is designed to improve the rotation of the oscillating member and reduce interference.

Furthermore, an end of the rotating member away from the oscillating member is provided with a mounting groove; and
the end of the transmission shaft assembly is provided with a mounting member fitting with the mounting groove; and the mounting member is penetrated by a pin to achieve synchronize motions of the rotating member and the transmission shaft assembly. The beneficial effect of this design lies in that the mounting groove and the pin fit with each other to achieve stable fit between the rotating member and the transmission shaft assembly.

Furthermore, the mounting member is flat-shaped, and alternatively the mounting member is provided with an elliptical longitudinal section.

Furthermore, the brush disc assembly includes:
a positioning sleeve, where an end of the positioning sleeve is provided with the groove, and two sides of the positioning sleeve are respectively provided with clamping grooves; and
a brush disc, where two sides of the brush disc are respectively provided with extension projections; and the extension projections respectively fit with the clamping grooves.

Furthermore, the positioning sleeve is a plastic part, while the oscillating member is a metal part or a plastic part. The beneficial effect of this design lies in that noise is further reduced.

The present disclosure further provides an electric cleaning brush, including the above-mentioned brush head for an electric cleaning brush.

One or more technical solutions provided in the embodiments of the present disclosure have at least the following technical effects or advantages:
1. In the present disclosure, the brush head includes a fit protrusion and a groove. In the transmission process, the fit protrusion presses against the groove to reduce noise generated by the brush head of the cleaning brush, thereby achieving low-noise stable operation of the brush head of the cleaning brush.
2. In the present disclosure, the wall of the groove is divided into two sections, avoiding the protruding section from being interfered and ensuring rotation of the fit protrusion.

### BRIEF DESCRIPTION OF THE DRAWINGS

To describe the technical solutions in the specific implementations of the present disclosure or the prior art more clearly, the drawings required for describing the specific implementations or the prior art are briefly described below. Apparently, the drawings in the following description show merely some implementations of the present disclosure, and a person of ordinary skill in the art may still derive other drawings from these drawings without creative efforts.

FIG. 1 is a structural schematic diagram of a brush head for an electric cleaning brush according to a specific embodiment of the present disclosure;

FIG. 2 is an internal structural schematic diagram of the brush head shown in FIG. 1;

FIG. 3 is a structural schematic diagram of a positioning sleeve shown in FIG. 1;

FIG. 4 is a structural schematic diagram of an oscillating member shown in FIG. 1;

FIG. 5 is a front view of the oscillating member shown in FIG. 1;

FIG. 6 is a structural schematic diagram of a transmission shaft assembly shown in FIG. 1 when the transmission shaft assembly rotates to a 12 o'clock direction; and

FIG. 7 is a structural schematic diagram of the transmission shaft assembly shown in FIG. 1 when the transmission shaft assembly rotates to a 9 o'clock direction.

### REFERENCE NUMERALS

1. housing; 2. brush disc assembly; 3. transmission shaft assembly; 4. oscillating member; and 5. groove;
101. accommodation chamber;
201. positioning sleeve; 202. clamping groove; 203. brush disc; and 204. extension projection;
401. rotating member; 402. fit protrusion; 403. mounting groove; 404. mounting member; and 405. pin; and
501. inclined section; and 502. vertical section.

### DETAILED DESCRIPTION OF THE EMBODIMENTS

The embodiments of the technical solutions of the present disclosure will be described in detail below with reference to the drawings. The following embodiments are only used to more clearly illustrate the technical solutions of the present disclosure. Therefore, these embodiments are merely exemplary and are not intended to limit the protection scope of the present disclosure.

It should be noted that the technical terms or scientific terms used herein should have the ordinary meanings as understood by those skilled in the art to which the present disclosure belongs, unless otherwise stated.

In the present disclosure, unless otherwise clearly specified, the terms such as “mounting”, “interconnection”, “connection” and “fixation” are intended to be understood in a broad sense. For example, the “connection” may be a fixed connection, removable connection or integral connection; may be a mechanical connection; may be a direct connection or indirect connection via a medium; and may be a communication or interaction between two elements. Those of ordinary skill in the art may understand specific meanings of the above terms in the present disclosure based on a specific situation.

For a better understanding of the foregoing technical solution, the following describes the foregoing technical solution in detail with reference to the drawings and specific implementations.

### Embodiment 1

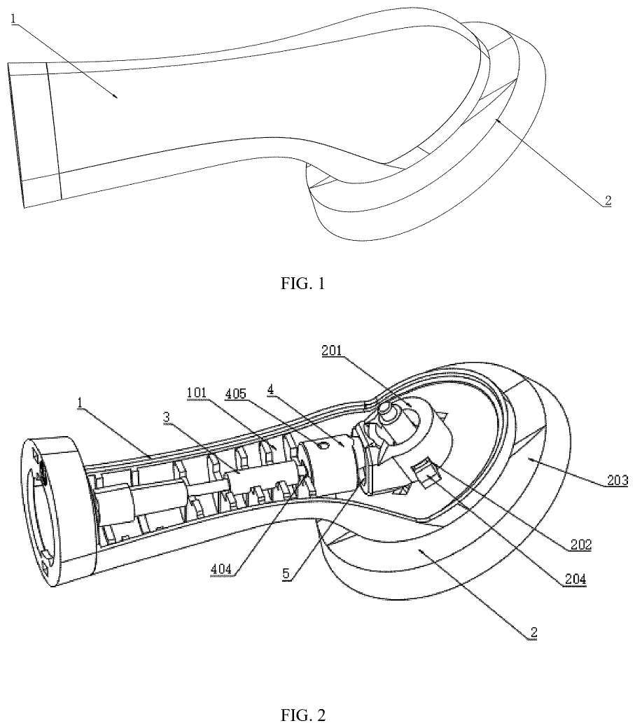

As shown in FIGS. 1 to 5, the embodiment of the present disclosure provides a brush head for an electric cleaning brush for sanitation cleaning. The brush head is internally provided with an oscillating member. A fit protrusion rotates to press against a brush disc assembly and drive the brush disc assembly to rotate. In this way, the present disclosure reduces noise during operation of the brush head while ensuring product service life.

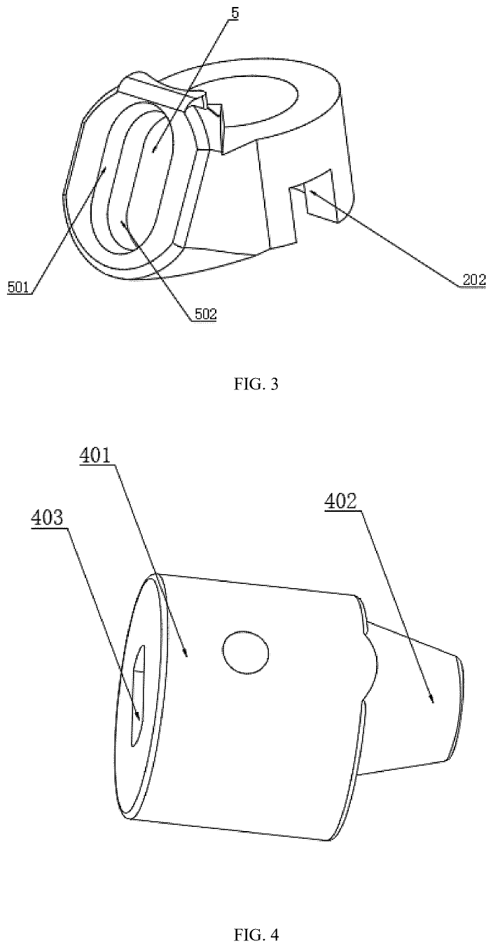

As shown in FIGS. 1 and 2, specific structures of the present disclosure are described as follows.

Housing 1 is internally provided with accommodation chamber 101. The housing 1 is an existing housing. Specifically, the housing 1 has a larger head portion for accommodating a brush disc assembly and a middle portion for accommodating a transmission shaft assembly and connected to a power member such as a motor. To ensure stability of the transmission shaft assembly and other components, a limiting plate can be provided. The limiting plate is provided with a corresponding groove to restrict the transmission shaft assembly for stability.

Brush disc assembly 2 is provided at an end of the housing 1. The brush disc assembly includes one end located outside the housing 1 and the other end extending into the accommodation chamber 101. That is, brush disc 203 includes one portion located outside the housing and the other portion located inside the accommodation chamber 101. The brush disc assembly 2 mainly performs cleaning actions for users through oscillating driven by the transmission shaft assembly. Specifically, a oscillate range of the brush disc assembly 2 is 20-30°.

Transmission shaft assembly 3 is provided in the accommodation chamber 101. The transmission shaft assembly 3 is spaced apart from the brush disc assembly 2. Specifically, the transmission shaft assembly 3 is located at the middle portion of the accommodation chamber 101. One end of the transmission shaft assembly is connected to a component such as the motor to achieve rotation, thereby driving the oscillating member to oscillate.

Oscillating member 4 is provided at an end of the transmission shaft assembly 3. The oscillating member 4 is movably connected to the brush disc assembly 2. The oscillating member 4 is driven by the transmission shaft assembly 3 to rotate, which in turn drives the brush disc assembly 2 to oscillate, thereby performing cleaning actions.

However, the existing movable connection method generates excessive noise. The present disclosure redesigns the oscillating member 4 and the brush disc assembly 2 to reduce noise, as specifically described below.

A side of the brush disc assembly 2 facing the oscillating member 4 is provided with groove 5.

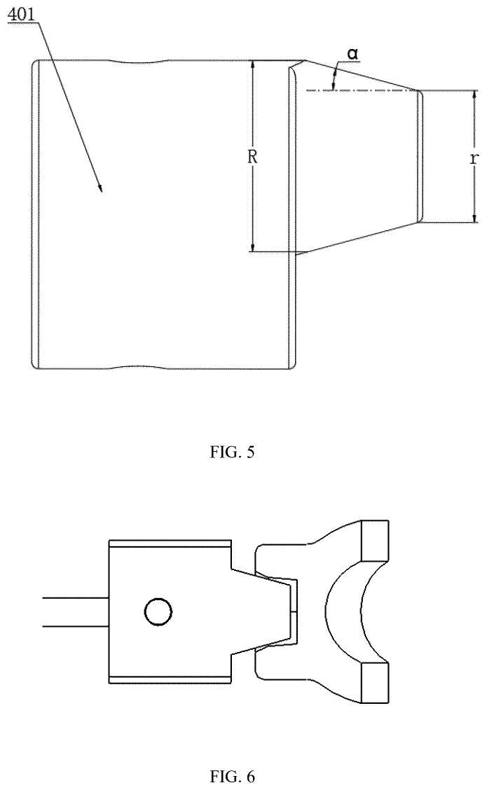

As shown in FIGS. 1 and 4, the oscillating member 4 includes a rotating member and a fit protrusion.

Rotating member 401 is provided at the end of the transmission shaft assembly 3.

The fit protrusion 402 includes one end provided at an eccentric position of the rotating member 401 and the other end with an outer wall fitting against an inner wall of the groove 5. In the present disclosure, the oscillating member 4 may be an integrally formed part or may include the rotating member 401 and the fit protrusion 402 that are fixedly connected to each other. The rotating member 401 may be cylindrical. The fit protrusion 402 is located at the eccentric position. The outer wall of the fit protrusion 402 presses against the inner wall of the groove 5 to drive the brush disc assembly 2 to oscillate, thereby performing cleaning actions.

Specifically, when the transmission shaft assembly 3 drives the rotating member 401 to rotate, the fit protrusion 402 is driven to perform eccentric motion. During this process, the fit protrusion 402 fits against the inner wall of the groove 5 to press against the groove 5 and drive the oscillating member 4 to oscillate. This design reduces impact and thereby decreases noise.

As shown in FIG. 5, in an embodiment, the fit protrusion 402 is truncated cone-shaped. A diameter of a side of the fit protrusion 402 away from the rotating member 401 is denoted as r, while a diameter of a side of the fit protrusion 402 close to the rotating member 401 is denoted as R, R>r. That is, the diameter of the end of the fit protrusion 402 close to the groove 5 is smaller, while the diameter of the end away from the groove 5 is larger, thereby better driving the brush disc assembly 2 to oscillate.

Specifically, in the present disclosure, a taper of the fit protrusion 402 is no less than 45° to facilitate design of the inner wall of the groove and reduce interference.

In another embodiment, to ensure stable motion of the brush disc assembly 2 and prevent interference between the oscillating member 4 and the groove 5, the shape and taper of the fit protrusion 402 are designed. The inner wall of the groove 5 is designed into an outwardly wide and inwardly narrow structure. Preferably, the groove 5 may be trumpet-shaped, or configured as shown in FIG. 3:

The inner wall of the groove 5 includes inclined section 501 and vertical section 502. The inclined section 501 is located at an end of the vertical section 502 away from a bottom of the groove 5. The inclined section 501 extends obliquely outward from a junction between the inclined section and the vertical section 502 to form a splayed pattern.

When the oscillating member 4 is driven by the transmission shaft assembly 3 to eccentrically rotate, the outer wall of the fit protrusion 402 contacts the vertical section 502. An inclination angle of the inclined section 501 may be the same as or different from the taper of the fit protrusion. During rotation, the fit protrusion 402 avoids interference through the inclined section 501.

In still another embodiment, the transmission shaft assembly 3 of the present disclosure may be an existing component including a joint sleeve, a transmission shaft, and a transmission shaft sleeve to ensure stable transmission. In the present disclosure, the transmission shaft assembly 3 is connected to the rotating member 401. The connection may be fixed or achieved through other components. Preferably, an end of the rotating member 401 away from the oscillating member 4 is provided with mounting groove 403.

The end of the transmission shaft assembly 3 is provided with mounting member 404 fitting with the mounting groove 403. The mounting member 404 is penetrated by pin 405 to achieve synchronize motions of the rotating member 401 and the transmission shaft assembly 3. That is, the mounting member 404 is inserted into the mounting groove 403 and fixed by the vertically penetrating pin to ensure synchronized motions of the rotating member 401 and the transmission shaft assembly 3.

To guarantee stable motion of the rotating member 401, the specific shape of the mounting member 404 is designed. The shape of the mounting groove 403 matches the mounting member 404 to achieve compatibility. Specifically, the mounting member 404 is flat-shaped, and alternatively the mounting member 404 is provided with an elliptical longitudinal section.

In yet another embodiment, in the present disclosure, the groove 5 is obround, U-shaped, or elliptical to facilitate oscillating of the brush disc assembly 2. A top surface of the fit protrusion 402 is parallel to the bottom of the groove 5.

To further ensure motion stability, the present disclosure also designs corresponding dimensions. Specifically, spacing between an outer end surface of the rotating member 401 and an inner end surface of the oscillating member 4 is denoted as a, and a width of an end of the oscillating member 4 facing the rotating member 401 is denoted as b, 8≤b/a≤16.

The present disclosure also designs the brush disc assembly 2 to make it better fit with the oscillating member 4. Specifically, the brush disc assembly 2 includes a positioning sleeve and a brush disc.

An end of the positioning sleeve 201 is provided with the groove 5, and two sides of the positioning sleeve 201 are respectively provided with clamping grooves 202.

Two sides of the brush disc 203 are respectively provided with extension projections 204. The extension projections 204 respectively fit with the clamping grooves 202. A through hole is provided at a middle portion of the positioning sleeve 201 to allow a shaft of the brush disc 203 to pass through. Preferably, a portion of the positioning sleeve 201 away from the oscillating member 4 is cylindrical, while the other portion of the positioning sleeve is a conical projection provided with the groove 5 fitting with the oscillating member 4. In the present disclosure, a gasket may be added to the extension projection 204 to ensure fit between the extension projection 204 and the clamping groove 202.

To further reduce noise, the present disclosure specifies material limitations. The positioning sleeve 201 is a plastic part. The oscillating member 4 is a metal part or a plastic part. In the present disclosure, the plastic part refers to one of polyamide (PA), polycarbonate (PC), polyoxymethylene (POM), acrylonitrile/butadiene/styrene copolymer (ABS), thermoplastic elastomer, polyimide (PI), polyphenylene sulfide (PPS), polybutylene terephthalate (PBT), polyether ether ketone (PEEK), and liquid crystal polymer (LCP).

The specific working process of the present disclosure is as follows.

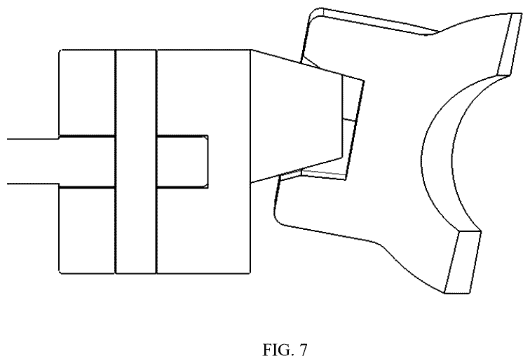

The driving assembly drives the transmission shaft assembly 3 to rotate. When the transmission shaft assembly 3 rotates, the fit protrusion 402 is driven to rotate. The fit protrusion 402 presses against the groove 5 during rotation. The brush disc assembly 2 oscillates under driving of the fit protrusion 402. That is, the brush disc assembly 2 is driven to oscillate, thereby performing cleaning actions. Specifically, two motion states are shown in FIGS. 6 and 7.

### Embodiment 2

Based Embodiment 1, the present disclosure further provides an electric cleaning brush, including the above-mentioned brush head for an electric cleaning brush.

Noise testing of the present disclosure is performed as follows.

The cleaning brush is placed in a noise chamber. The linear distance (horizontal and vertical) between the head of the cleaning brush and the sound level meter is 30 CM. The cleaning brush is activated, and the noise chamber is closed. Noise values recorded by the sound level meter within 1 minute recorded (every 10 seconds) and averaged. The noise measures only 60-75 dB, indicating a reduction of at least 5-10 dB.

Lots of specific details are presented in the specification of the present disclosure. However, it can be understood that the embodiments of the present disclosure can be practiced without the specific details. In some embodiments, well-known methods, structures and techniques are not shown in detail to avoid obscuring the understanding of this specification.

In this specification, the description of “one embodiment”, “some embodiments”, “an example”, “a specific example” and “some examples” means that a specific feature, structure, material or characteristic described in combination with the embodiment(s) or example(s) is included in at least one embodiment or example of the present disclosure. In this specification, the schematic expression of the above terms is not necessarily directed to the same embodiment or example. Furthermore, the specific features, structures, materials, or characteristics described may be combined in a suitable manner in any one or more of embodiments or examples. In addition, those skilled in the art may combine different embodiments or examples described in this specification and characteristics of the different embodiments or examples without mutual contradiction.

Finally, it should be noted that the above embodiments are provided merely for describing the technical solutions of the present disclosure, but not for limiting the present disclosure. Although the present disclosure is described in detail with reference to the above embodiments, a person of ordinary skill in the art should understand that they may still make modifications to the technical solutions described in the above embodiments or make equivalent replacements to some or all technical features thereof; and these modifications or replacements do not make the essence of the corresponding technical solution depart from the scope of the technical solutions of the embodiments of the present disclosure, and shall fall within the scope of claims and specification of the present disclosure.

What is claimed is:

1. A brush head for an electric cleaning brush, comprising:
a housing, wherein the housing is internally provided with an accommodation chamber;
a brush disc assembly, provided at an end of the housing;
a transmission shaft assembly, wherein the transmission shaft assembly is provided in the accommodation chamber, and spaced apart from the brush disc assembly; and
an oscillating member, wherein the oscillating member is provided at an end of the transmission shaft assembly and movably connected to the brush disc assembly;
wherein a side of the brush disc assembly facing the oscillating member is provided with a groove;
the oscillating member comprises:
a rotating member, provided at the end of the transmission shaft assembly; and
a fit protrusion, comprising a first end provided at an eccentric position of the rotating member and a second end with an outer wall fitting against an inner wall of the groove.

2. The brush head for the electric cleaning brush according to claim 1, wherein the fit protrusion is truncated cone-shaped; and a diameter of a side of the fit protrusion away from the rotating member is denoted as r, while a diameter of a side of the fit protrusion adjacent to the rotating member is denoted as R, R>r.

3. The brush head for the electric cleaning brush according to claim 2, wherein a taper of the fit protrusion is denoted as α, α≥45°.

4. The brush head for the electric cleaning brush according to claim 1, wherein the inner wall of the groove comprises an inclined section and a vertical section; the inclined section is located at an end of the vertical section away from a bottom of the groove; and the inclined section extends obliquely outward from a junction between the inclined section and the vertical section; and
when the oscillating member is driven by the transmission shaft assembly to eccentrically rotate, the outer wall of the fit protrusion contacts the vertical section.

5. The brush head for the electric cleaning brush according to claim 1, wherein an end of the rotating member away from the oscillating member is provided with a mounting groove;
and
the end of the transmission shaft assembly is provided with a mounting member fitting with the mounting groove; and the mounting member is penetrated by a pin to achieve synchronize motions of the rotating member and the transmission shaft assembly.

6. The brush head for the electric cleaning brush according to claim 5, wherein the mounting member is flat-shaped, or the mounting member is provided with an elliptical longitudinal section.

7. The brush head for the electric cleaning brush according to claim 1, wherein the groove is obround or U-shaped.

8. The brush head for the electric cleaning brush according to claim 1, wherein the brush disc assembly comprises:
a positioning sleeve, wherein an end of the positioning sleeve is provided with the groove, and two sides of the positioning sleeve are respectively provided with clamping grooves; and
a brush disc, wherein two sides of the brush disc are respectively provided with extension projections; and the extension projections respectively fit with the clamping grooves.

9. The brush head for the electric cleaning brush according to claim 8, wherein the positioning sleeve is a plastic part, while the oscillating member is a metal part or a plastic part.

10. An electric cleaning brush, comprising the brush head for the electric cleaning brush according to claim 1.

11. The electric cleaning brush according to claim 10, wherein in the brush head, the fit protrusion is truncated cone-shaped; and a diameter of a side of the fit protrusion away from the rotating member is denoted as r, while a diameter of a side of the fit protrusion adjacent to the rotating member is denoted as R, R>r.

12. The electric cleaning brush according to claim 11, wherein in the brush head, a taper of the fit protrusion is denoted as α, α≥45°.

13. The electric cleaning brush according to claim 10, wherein in the brush head, the inner wall of the groove comprises an inclined section and a vertical section; the inclined section is located at an end of the vertical section away from a bottom of the groove; and the inclined section extends obliquely outward from a junction between the inclined section and the vertical section; and
when the oscillating member is driven by the transmission shaft assembly to eccentrically rotate, the outer wall of the fit protrusion contacts the vertical section.

14. The electric cleaning brush according to claim 10, wherein in the brush head, an end of the rotating member away from the oscillating member is provided with a mounting groove; and
the end of the transmission shaft assembly is provided with a mounting member fitting with the mounting groove; and the mounting member is penetrated by a pin to achieve synchronize motions of the rotating member and the transmission shaft assembly.

15. The electric cleaning brush according to claim 14, wherein in the brush head, the mounting member is flat-shaped, or the mounting member is provided with an elliptical longitudinal section.

16. The electric cleaning brush according to claim 10, wherein in the brush head, the groove is obround or U-shaped.

17. The electric cleaning brush according to claim 10, wherein in the brush head, the brush disc assembly comprises:
a positioning sleeve, wherein an end of the positioning sleeve is provided with the groove, and two sides of the positioning sleeve are respectively provided with clamping grooves; and
a brush disc, wherein two sides of the brush disc are respectively provided with extension projections; and the extension projections respectively fit with the clamping grooves.

18. The electric cleaning brush according to claim 17, wherein in the brush head, the positioning sleeve is a plastic part, while the oscillating member is a metal part or a plastic part.
